(19) United States
(12) Patent Application Publication
(10) Pub. No.: US 2026/0269784 A1
(43) Pub. Date: Sep. 10, 2026

(54) HYBRID PHOTOVOLTAIC THERMAL ENERGY SYSTEM

(71) Applicant: MAIERTECH SOLUTIONS GMBH, Königsbrunn (DE)

(72) Inventors: Waldemar MAIER, Königsbrunn (DE); Viktor MAIER, Königsbrunn (DE); Hamed HANIFI, Königsbrunn (DE)

(73) Assignee: MAIERTECH SOLUTIONS GMBH, Königsbrunn (DE)

(21) Appl. No.: 19/166,248

(22) PCT Filed: Mar. 18, 2024
(86) PCT No.: PCT/EP2024/057143

§ 371 Date: Sep. 17, 2025

(30) Foreign Application Priority Data
Mar. 17, 2023 (EP) 23162554.2

(51) Int. Cl. H02S 40/44; H02S 40/42

(52) U.S. Cl. CPC H02S 40/44; H02S 40/425

(57) ABSTRACT

A hybrid photovoltaic thermal energy system for generating electrical and thermal energy, including a photovoltaic module with a first side and a second side opposite the first side. The first side of the photovoltaic module is configured to receive solar energy and convert it into electrical energy. A cooling structure, the cooling structure is arranged on the second side of the photovoltaic module and is configured to receive a cooling fluid for cooling the photovoltaic module. An inlet for introducing the cooling fluid into the cooling structure and an outlet for discharging the cooling fluid from the cooling structure.

### FIELD

The present invention relates to a hybrid photovoltaic thermal energy system for generating electrical and thermal energy.

### BACKGROUND

Photovoltaic systems are generally known and used to convert light energy into electricity. They make an important contribution to the goal of doing without fossil fuels in the medium term and reducing CO2 emissions.

In a further development of classic photovoltaic systems, also known as a hybrid photovoltaic thermal energy system or PVT system, not only the solar energy is converted into electricity and used, but the thermal energy generated by photovoltaic modules is also utilized, for example for warm water treatment. This is particularly efficient because a photovoltaic module typically converts more than 70% of the solar energy absorbed into heat and only around 20% of the solar energy absorbed can be converted into electricity.

Several PVT systems are already known from the prior art. WO 2022/255861 A1 describes a heating and/or cooling module for a photovoltaic module. DE 20 2015 008919 U1 discloses a cooling module for a photovoltaic unit. CN 114 978 032 A describes a PVT system with a heating unit, a storage battery and a pump. WO 2009/046352 A2 describes another PVT system. DE 10 2007 001206 A1 discloses a photovoltaic module with an integrated cooling system. DE 10 2013 008957 A1 describes a PVT system with two flow connections and two return connections.

A typical structure of a PVT system known from the prior art is shown in FIG. 1. The PVT system 10 shown here comprises a frame 12 that is typically made of aluminum. A glass plate 14 is arranged in the frame 12, which covers a photo-voltaic module 16 and protects it from rain, dust and dirt. An electrical insulator 18 is provided below the photovoltaic module 16. The electrical insulator 18 separates the photovoltaic module 16 from a tube 20, which is arranged below the photovoltaic module 16. The tube 20 is typically made of a metal, wherein preferably aluminum, copper or steel can be used. The metal tube 20 is meander-shaped and has an inlet 22 and an outlet 24. A cooling fluid is introduced into the metal tube 20 through the inlet 22. The cooling fluid flows through the metal tube 20 and heats up due to the increased temperature of the photovoltaic module 16. The heated fluid then flows out of the metal tube 20 through the outlet 24. The heated fluid can then be used to heat a radiator or swimming pool, for example. Finally, a heat insulator 26 is provided below the metal tube 20 in the PVC system shown in FIG. 1, which serves to ensure that as little as possible of the heat stored in the metal tube 20 is lost.

The prior art PVT systems described above offer the advantage that part of the thermal energy generated by solar radiation in photovoltaic modules can be utilized, thereby increasing the overall efficiency of the photovoltaic system. An additional advantage of the PVT systems described in the prior art is that the photovoltaic modules used are simultaneously cooled by the cooling fluid, which increases the efficiency of the photovoltaic modules, as the efficiency of most photovoltaic modules is known to decrease with increasing temperature.

However, the PVT systems described in the prior art also have some disadvantages. On the one hand, the systems described are relatively expensive, as the cooling tube described is complex to manufacture and the metal used in the cooling tube is relatively expensive. Another disadvantage of the PVT systems known from the prior art is that the photovoltaic modules are not cooled particularly homogeneously and efficiently.

### SUMMARY

Based on the disadvantages of the prior art discussed above, it is the object of the present invention to provide a PVT system (also referred to as a hybrid photovoltaic thermal energy system in the context of the present invention) that enables particularly homogeneous and efficient cooling of the photovoltaic modules and is also particularly simple and inexpensive to manufacture.

The aforementioned object is achieved with the present invention proposing a hybrid photovoltaic thermal energy system (PVT system) for generating electrical and thermal energy, the PVT system comprising:
a photovoltaic module with a first side and a second side opposite the first side, wherein the first side of the photovoltaic module is configured to receive solar energy and convert it into electrical energy;
a cooling structure, wherein the cooling structure is arranged on the second side of the photovoltaic module and is configured to receive a cooling fluid for cooling the photovoltaic module;
an inlet for introducing the cooling fluid into the cooling structure and an outlet for discharging the cooling fluid from the cooling structure.

The cooling structure can have one or more chambers that can receive the cooling fluid. In particular, the cooling structure can be cuboid and flat, wherein the length and width of the cooling structure l_KS, b_KS can correspond to the length and width of the photovoltaic module l_PM, b_PM. For example, it may be provided that the width of the cooling structure b_KS is at least 80% or 90% of the width of the photovoltaic module b_PM, while the length of the cooling structure l_KS is at least 80% or 90% of the length of the photovoltaic module l_PM. In addition, the thickness of the cooling structure can be d_KS<0.1×l_KS, and preferably d_KS<0.05 l_KS. In other words, the cooling structure can be particularly flat.

The use of a cooling structure on the rear side of the photovoltaic module offers the advantage that the incident light rays are not impaired by the cooling structure and in particular are not attenuated, but that the entire light intensity can reach the corresponding photovoltaic module. Compared to the use of a meander-shaped metal tube, the use of a flat cooling structure also has the advantage that it enables particularly homogeneous cooling of the photovoltaic module. The heat from the photovoltaic module can be dissipated particularly efficiently, as the cooling structure and the photovoltaic module are in contact over a large area and, ideally, the cooling structure contacts the entire rear side of the photovoltaic module. This means that a large proportion of the available heat energy can be dissipated and reused, for example to heat a radiator, a swimming pool, a hot water tank or a buffer tank. In addition, the production of a cuboid cooling structure is significantly simpler and cheaper than the production of a meander-shaped metal tube.

Preferably, it may be provided that the cooling structure has a flat first chamber, wherein the first chamber has a first side and a second side opposite the first side, and the first side of the first chamber is arranged on the second side of the photovoltaic module. In particular, the first chamber can be cuboid in shape, wherein the first chamber has a length l_K1, a width b_K1 and a thickness d_K1 and d_K1<0.1 l_K1 applies, and in particular d_K1<0.05 l_K1 applies. According to this embodiment of the invention, it may be provided that the inlet and the outlet are directly connected to the first chamber and that the cooling fluid can thus be introduced directly into the first chamber through the inlet.

Furthermore, it may be provided that the cooling structure has a second chamber which is arranged on the second side of the first chamber and which is connected to the first chamber via an opening, wherein the opening can in particular be slit-shaped or circular. According to this embodiment of the invention, it may be provided that the inlet is connected to the second chamber and that the inlet is configured to introduce the cooling fluid into the first chamber indirectly via the second chamber. The second chamber has a length l_K2, a width b_K2 and a thickness d_K2, wherein the preferred ratio is 0.5<d_K2/b_K2<1.5. In other words, the second chamber is preferably not flat, but has an almost square cross-sectional area. This allows a relatively large amount of cooling fluid to be temporarily stored in the second chamber before it is introduced into the preferably flat first chamber. This additional reservoir allows the photovoltaic module to be cooled particularly efficiently.

According to an embodiment of the present invention, it may be provided that the first chamber is formed of a first layer and a second layer opposite the first layer, as well as sidewalls extending from the first layer to the second layer, wherein the second layer is arranged on the second side of the photovoltaic module. The layers can be designed as robust plates or as flexible layers. This ensures that the structure of the first chamber is particularly simple. In addition, the cooling structure with the first chamber described above offers the advantage that it has a flat contact element for contacting the second side of the photovoltaic module and thus allows particularly efficient cooling of the photo-voltaic module.

According to the present invention, it may further be provided that the first chamber is formed by the first layer, the photovoltaic module and sidewalls extending from the first layer to the second side of the photovoltaic module. In this way, a particularly simple and cost-effective cooling structure can be provided.

Furthermore, it may be provided in the present invention that the first layer or the second layer has a surface structure, or alternatively both layers have a surface structure. In particular, the surface structure can be groove-shaped or the surface structure can provide channel walls that run parallel or orthogonal to the longitudinal axis of the first layer and/or the second layer and define individual channels within the first chamber. Thus, various channels can be formed in the first chamber, which determine the direction of flow of the cooling fluid. The channels within the first chamber can be particularly elongated. The surface structure can be created by an ablative process or by an application process. For example, a mechanical ablation process or a laser ablation process can be used to create the aforementioned groove-like surface structure on the surface of a layer. It may also be provided that a 3D printing process is used to apply the channel walls described above to one of the layers.

Furthermore, it may be provided that the channel walls extend continuously from one side of the first chamber to the opposite side of the first chamber. In doing so, the channels can run parallel to the longitudinal axis of the photovoltaic module or the first chamber, or orthogonally to this longitudinal axis. This means that numerous channels can be arranged next to each other, allowing a particularly high amount of cooling fluid to flow through the first chamber. Due to the customizable surface structure, the amount of cooling fluid that can be passed through the cooling chamber and the direction of flow can be individually configured depending on the field of application.

According to a preferred embodiment of the present invention, it may also be provided that at least one channel wall has at least one interruption, with at least one interruption preferably being provided in the center of a channel wall. A continuous channel wall, which extends from one side of the first chamber to the opposite side of the first chamber, has the advantage that the direction of flow of the cooling fluid is clearly defined within the entire channel and the flow of the cooling fluid is easy to calculate. Whereas in some applications it can be advantageous not to design the channel wall to be continuous, but to provide interruptions within the channel wall. The deliberate implementation of the aforementioned interruptions in the channel wall makes it possible for the cooling fluid to escape even in the event of a blocked channel and to flow through one or more neighboring channels. In other words, the aforementioned interruptions in the channel wall provide alternative flow paths within the first chamber through which the cooling fluid can flow in the event of a blocked channel. Advantageously, this can significantly reduce the risk of insufficient cooling in the event of blocked channels. According to some embodiments of the present invention, it may be provided that all channel walls have interruptions, wherein the interruptions may preferably be provided in the center of the channel walls.

According to the present invention, it may also be provided that the first chamber is designed as a continuous chamber. According to this embodiment, the first chamber therefore has no channel walls that would divide the first chamber into individual channels. This provides a first chamber that is completely free of any channel walls, allowing a particularly large amount of cooling fluid to flow through the first chamber. This enables particularly efficient cooling of the photovoltaic module and efficient use of thermal energy at the same time.

According to the present invention, it may be provided that the first chamber is made of a plastic material, in particular polycarbonate or polymethyl methacrylate, PMMA. It may also be provided that the first chamber is made of a light metal (e.g. aluminum, magnesium or titanium) or glass. This means that the first chamber or cooling structure can be manufactured particularly cost-effectively. At the same time, the overall weight of the PVT system can be kept low. The first chamber can selectively be made of either a transparent or a non-transparent material. The use of a transparent material offers the advantage that the first chamber can be connected to adjacent components by means of a welding process.

Furthermore, it may be provided in the present invention that spacers are arranged between the first layer and the second layer, which define the thickness of the first chamber. The spacers, which according to some embodiments of the present invention are designed as separate components, can in particular be bonded to the first layer and/or to the second layer. Alternatively, the spacers can be welded to the first layer and/or to the second layer. Furthermore, it may be provided that the spacers are integrally formed with the first layer and/or the second layer. On the one hand, the spacers help to ensure that the distance between the first layer and the second layer can be defined easily and also make it particularly easy to assemble the first chamber. The spacers also contribute to the mechanical stability of the first chamber. This is particularly advantageous if the first chamber has one or two layers made of plastic or glass. The use of spacers offers the additional advantage that the first chamber can be adjusted particularly easily depending on the requirements in a specific field of application by exchanging spacers.

In particular, the spacers can be made from a plastic material, a light metal or from glass or glass fiber. However, the spacers are not limited to the above-mentioned materials.

According to some embodiments of the present invention, it may also be provided that the spacers have a circular, annular, rectangular or triangular cross-section and a thickness which is less than 20 mm, preferably less than 10 mm, and particularly preferably less than 5 mm. The maximum dimension of the spacers (i.e., the diameter of a circular structure, the outer diameter of an annular structure, the longer side of a rectangular structure, or the longest side of a triangular structure) may be a maximum of 10 cm, a maximum of 5 cm, or a maximum of 2 cm, according to some embodiments.

Furthermore, it may be provided that the first layer and/or the second layer have several receiving structures which are configured to receive the spacers. For example, the receiving structures can be designed as receiving grooves, which are designed depending on the shape of the spacers provided. In particular, the receiving grooves can therefore be circular, rectangular or triangular in shape. The receiving structures or the receiving grooves offer the advantage that the receiving structures can be received easily and quickly by inserting them into the receiving structures and, if necessary, clamping them into the receiving structures. According to this embodiment, it is therefore not necessary to glue or weld the spacers. Consequently, one and the same chamber can be used for different applications by adding or removing several spacers. It may also be provided that the receiving structure is arranged equidistantly on the first layer and/or on the second layer.

It is may also be provided to use an adhesive or an adhesive material or a composite material as a spacer. This makes it particularly easy to apply the required spacers to the first layer and/or the second layer. Overall, this can significantly simplify and accelerate the manufacturing process.

Preferably, it may be provided that the spacers can be made of plastic. As a result, the overall weight of the PVT system can be kept low, while plastic materials guarantee the mechanical stability required for the PVT systems according to the invention. In addition, the use of plastic spacers is particularly advantageous if the first layer or the second layer is made of glass. In this case, plastic spacers offer particularly advantageous mechanical stability and reduce the risk of possible glass breakage.

According to the present invention, it may further be provided that the cooling structure comprises a third layer, wherein the second layer is arranged between the first layer and the third layer. This can provide a first chamber, which is formed between the first layer and the second layer, and a third chamber, which is formed between the second layer and the third layer.

According to a further embodiment of the present invention, it may be provided that the cooling structure comprises a first chamber and a third chamber, wherein the first chamber may be formed between the photovoltaic module and the first layer and the third chamber may be formed between the first layer and the second layer. This means that only two layers (and corresponding sidewalls) are required to create two separate chambers.

Furthermore, it may be provided according to the present invention that the cooling structure comprises a first chamber and a third chamber, wherein the first chamber is formed between a first layer and a second layer and the third chamber is formed between the second layer and the third layer. Moreover, spacers can also be provided between the first layer and the second layer and between the second layer and the third layer. Alternatively, it may be provided that the second layer has a surface structure on each of its sides opposite the first layer and the third layer, which define several channels. The surface structures can be formed continuously or have interruptions (as described above).

In the case that two layers are used to provide two separate chambers, it may be provided that the spacers are located between the photovoltaic module and the first layer and between the first layer and the second layer. Furthermore, it may be provided that the first layer, which is arranged between the photovoltaic module and the second layer, has a surface structure on one or both sides facing the photovoltaic module or the second layer, respectively.

Finally, in the system according to the invention, it may be provided that the photovoltaic module is designed as a bifacial photovoltaic module with two photoelectrically active sides and that the first chamber of the cooling structure is arranged between the two active sides of the bifacial photovoltaic module. This enables particularly efficient cooling of the bifacial photovoltaic module. In doing so, a single chamber can be used, which simultaneously cools both photoelectrically active sides of the bifacial photovoltaic module, or two chambers, one of which is configured to cool one photoelectrically active side of the bifacial photovoltaic module.

### BRIEF DESCRIPTION OF THE DRAWINGS

In the following, the present invention is described in more detail with reference to the Figures. The Figures show the following:

FIG. 1 shows a PVT system according to the prior art,

FIG. 2 shows an exemplary embodiment of the PVT system according to the invention,

FIG. 3 shows another exemplary embodiment of the PVT system according to the invention,

FIG. 4 shows a PVT system according to an exemplary embodiment of the present invention,

FIG. 5 shows an enlarged view of the exemplary embodiment of the present invention shown in FIG. 4, which shows a possible configuration of the cooling structure,

FIG. 6 shows an exemplary embodiment of the first chamber according to the present invention with continuous channel walls,

FIG. 7 shows another exemplary embodiment of the first chamber according to the present invention with interrupted channel walls,

FIG. 8 shows another exemplary embodiment of the first chamber according to the present invention,

FIG. 9 shows another exemplary embodiment of the first chamber according to the present invention,

FIG. 10 shows another exemplary embodiment of the first chamber according to the present invention, and

FIG. 11 shows another exemplary embodiment of the first chamber according to the present invention.

### DETAILED DESCRIPTION

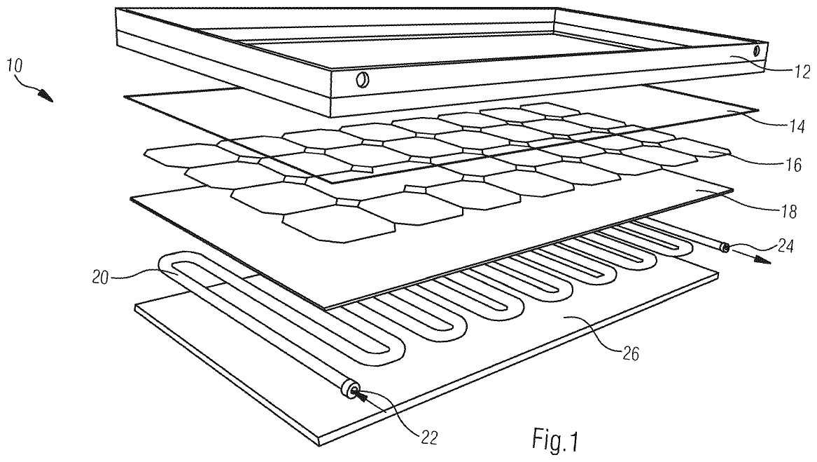

FIG. 1 shows a PVT system 10 according to the prior art and has already been discussed in the introductory part of the description.

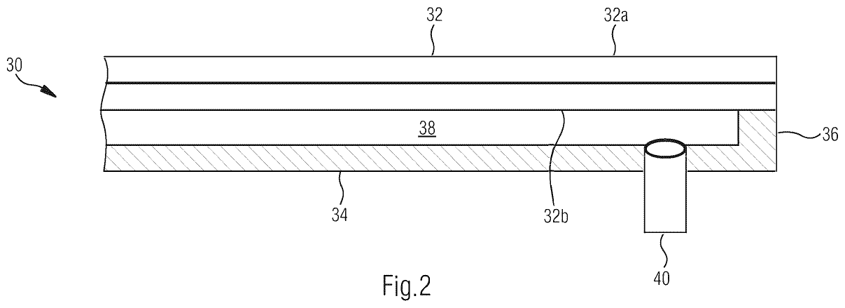

FIG. 2 shows an exemplary embodiment of the PVT system 30 according to the invention. The PVT system 30 has a photovoltaic module 32 as is known from the prior art. The photovoltaic module has a first side 32a and a second side 32b opposite the first side 32a. The first side 32a of the photovoltaic module 32 is configured to receive solar energy and convert it into electrical energy. The PVT system 30 also has a first layer 34 arranged on the second side 32b of the photovoltaic module 32. The first layer 34 together with the photovoltaic module 32 and the sidewall 36, which extends from the first layer 34 to the photovoltaic module 32, forms a first chamber 38. The PVT system 30 shown in FIG. 2 has a cooling structure with a chamber (“first chamber 38”) configured to evenly cool the photovoltaic module 32 and thereby dissipate the generated thermal energy from the photovoltaic module 32. The dissipated thermal energy can then be used to heat a radiator or swimming pool, for example. Using the cooling structure therefore achieves two effects simultaneously, namely on the one hand the absorption of thermal energy for subsequent use and on the other hand the cooling of the photovoltaic module 32 to increase its energy efficiency. As shown in FIG. 2, the illustrated PVT system 30 is also provided with an inlet 40 configured to introduce a cooling fluid into the first chamber 38. The cooling fluid heated in the first chamber 38 by the heated photovoltaic module 32 can then be led out of the chamber via an outlet (not shown in FIG. 2) and used to heat a radiator or a swimming pool.

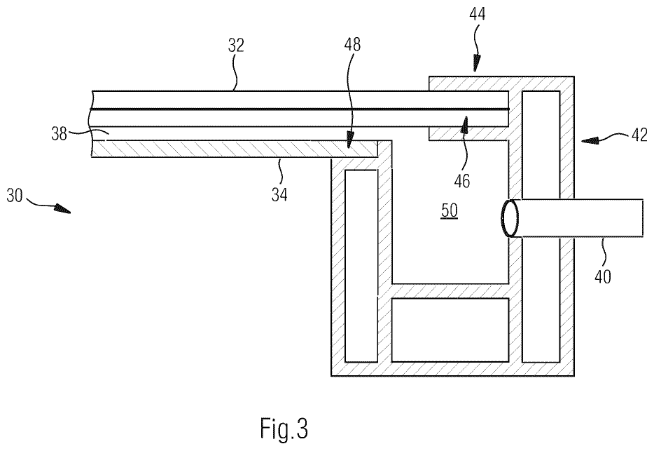

FIG. 3 shows another exemplary embodiment of the PVT system 30 according to the invention. The PVT system 30 shown in this figure additionally has a frame 42, which can be made of aluminum or a plastic material, for example. The frame 42 comprises a first support structure 44 configured to receive the photovoltaic module 32. In the exemplary embodiment shown in FIG. 3, the first support structure 44 has a receiving groove 46 through which the solar module 32 can be held in a stable manner. In addition, the frame 42 has a second support structure 48 which is configured to receive the first layer 34. For example, the second support structure 48 can be designed as a receiving groove (similar to the first support structure 44) or as a receiving step (as shown in FIG. 3). In addition, a second chamber 50 is provided in the PVT system 30 shown in FIG. 3, which is adjacent to the first chamber 38. The first chamber 38 and the second chamber 50 are connected to each other via an opening. The opening can be circular or slit-shaped, for example. According to the PVT system 30 shown in FIG. 3, the inlet 40 is configured to first introduce a cooling fluid into the second chamber 50, from where the cooling fluid is then guided into the first chamber 38 via the aforementioned opening. The use of the aforementioned frame 42 is advantageous on the one hand because it allows the photo-voltaic module 32 and the first layer 34 to be held stably, and on the other hand because the second chamber 50 provides a reservoir in which the cooling fluid can be temporarily stored before it is introduced into the first chamber 38. This ensures particularly efficient cooling of the photovoltaic module 32.

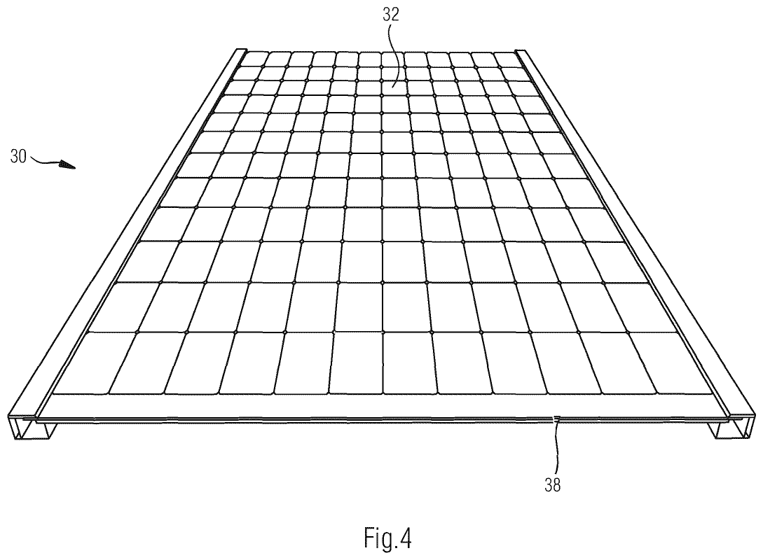

FIG. 4 shows a PVT system 30 according to an exemplary embodiment of the present invention, As can be seen in this figure, the PVT system 30 has a flat photovoltaic module 32 that has a length and a width that are each significantly greater than the thickness of the photovoltaic module 32. In addition, it can be seen in this figure that a cooling structure with a first chamber 38 is provided below the photovoltaic module 32, through which a cooling fluid can flow, whereby the photovoltaic module 32 can be cooled extensively and therefore in a homogeneous manner. As can also be seen in FIG. 4, the first chamber 38 or the cooling structure comprising the first chamber can be configured such that its surface covers almost the entire rear side of the photovoltaic module 32. This enables particularly efficient cooling of the photovoltaic module 32.

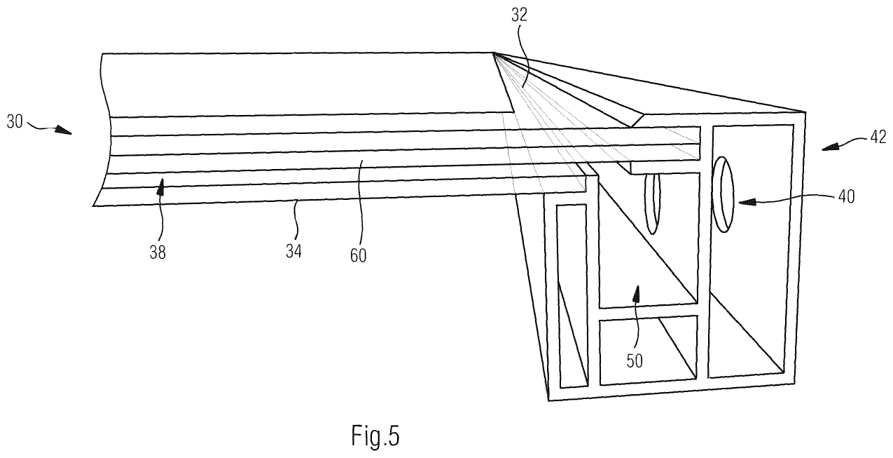

FIG. 5 shows an enlarged view of the exemplary embodiment of the PVT system 30 according to the invention shown in FIG. 4, wherein a possible configuration of the cooling structure is shown in this figure. The cooling structure shown in this figure has a first chamber 38 and a second chamber 50, which are connected to each other via an opening. In the exemplary embodiment shown here, the first chamber is delimited by a first layer 34 and a second layer 60. The cooling fluid is introduced into the second chamber 50 through the inlet 40, wherein the cooling fluid then passes from the second chamber 50 into the first chamber 38.

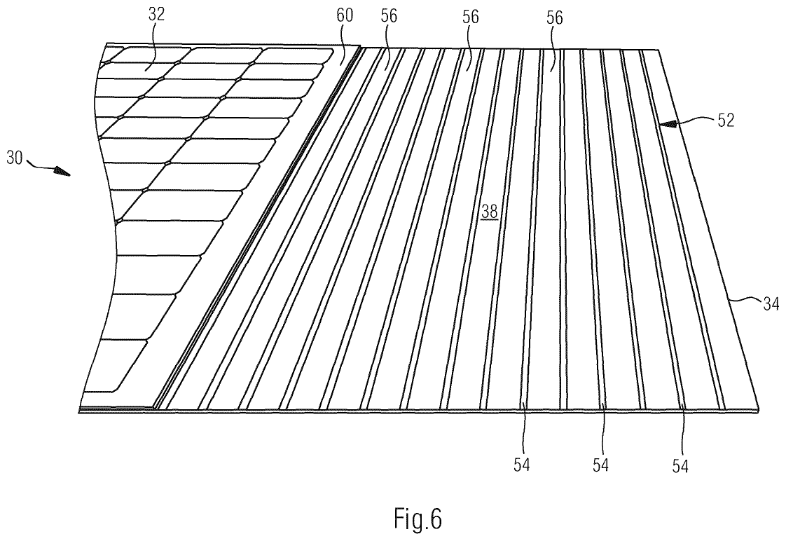

FIG. 6 shows an exemplary embodiment of the first chamber 38 of the PVT system 30. In this exemplary embodiment, the first chamber 38 is delimited by a first layer 34 and a second layer 60. The first layer 34 has a surface structure 52. In the exemplary embodiment shown in FIG. 6, the surface structure 52 is in the form of continuous channel walls 54 which extend from one side of the first layer 34 to the opposite side of the first layer 34 and run parallel to each other. Thus, the channel walls 54 define several parallel channels 56 through which the cooling fluid can flow. In this way, a relatively large amount of cooling fluid can flow through the first chamber 38, wherein the direction of flow of the cooling fluid within the first chamber 38 can be individually adjusted. In the exemplary embodiment shown in FIG. 6, the channels 56 run parallel to the longitudinal axis of the first chamber 38 or the first layer 34 and the photovoltaic module 32. Alternatively, the channel walls 54 and the channels 56 defined by the channel walls 54 may also extend orthogonally to the aforementioned longitudinal axis of the first chamber 38. According to some embodiments of the present invention, it may be provided that the width of the channels 56 is at least 3x, 5x or at least 10x the width of the channel walls 54. In this way, a particularly large amount of cooling fluid can flow through the first chamber, thereby achieving efficient cooling of the photovoltaic module 32.

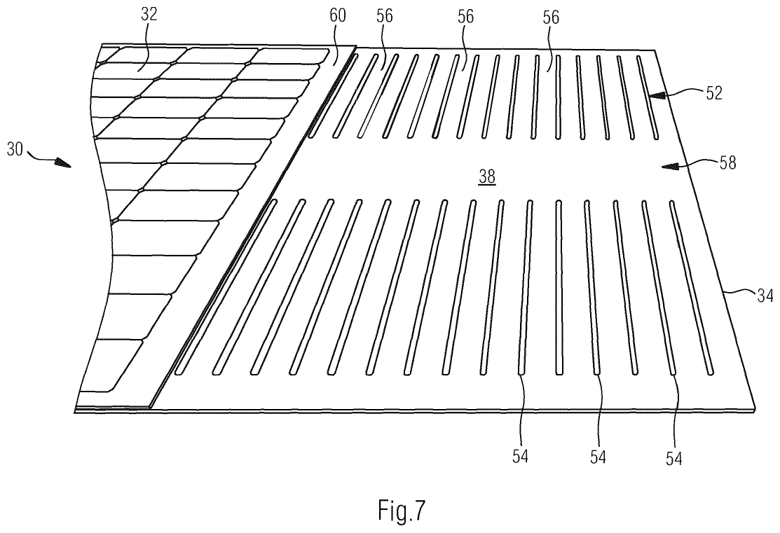

FIG. 7 shows another exemplary embodiment of the first chamber 38 of the PVT system 30 according to the present invention. In this exemplary embodiment, the channel walls 54 are no longer continuous, as was the case in the exemplary embodiment shown in FIG. 6. Instead, the channel walls 54 each have an interruption 58, which is provided approximately in the center of the channel walls 54. The interrupted configuration of the channel walls 54 makes it possible to direct the cooling fluid through one or more neighboring channels 56 in the event of a blocked channel 56. This significantly reduces the risk of inefficient cooling of the photovoltaic module 32, which can otherwise occur in the case of individual blocked channels 56.

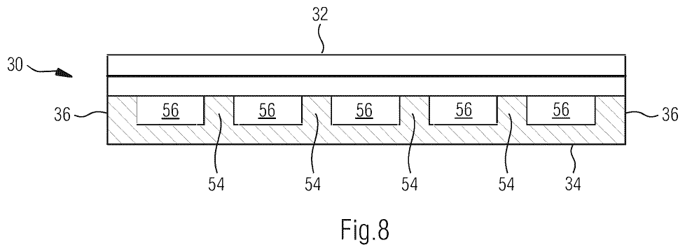

FIG. 8 shows another exemplary embodiment of the first chamber, wherein the first chamber is delimited by the first layer 34, the solar module 32 and the sidewalls 36. Individual channel walls 54 are provided within the first chamber, which define the individual channels 56 that run parallel to each other. According to the embodiment shown in FIG. 8, the use of a second layer is not necessary, since the first chamber is delimited at the top by the rear side of the photovoltaic module (also referred to above as “second side 32b of the photovoltaic module”).

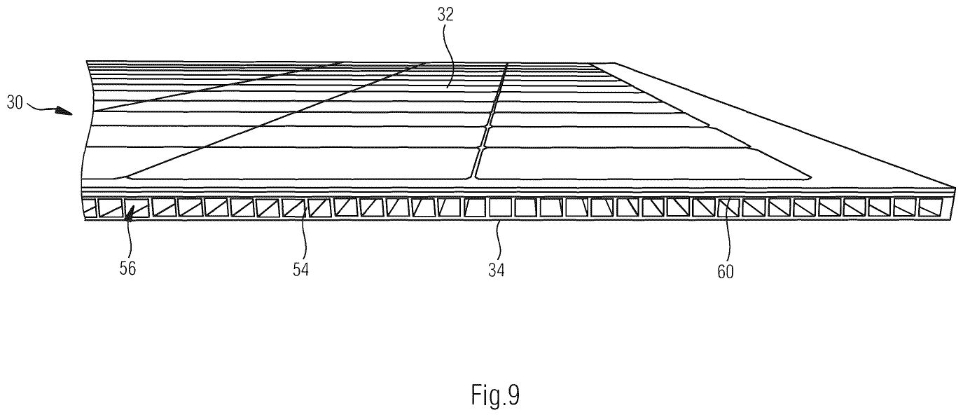

FIG. 9 shows another exemplary embodiment of the first chamber according to the present invention. In this exemplary embodiment, the cooling structure has a first chamber defined by the first layer 34 and the second layer 60, and side-walls extending from the first layer 34 to the second layer 60. The first chamber is divided into individual channels 56 by individual channel walls 54. The channels 56 run parallel to each other and have a substantially rectangular cross-section. The first chamber according to the embodiment shown in FIG. 9 can be in the form of a polycarbonate plate. Such polycarbonate plates are commercially available and inexpensive to manufacture and are also used in green-houses.

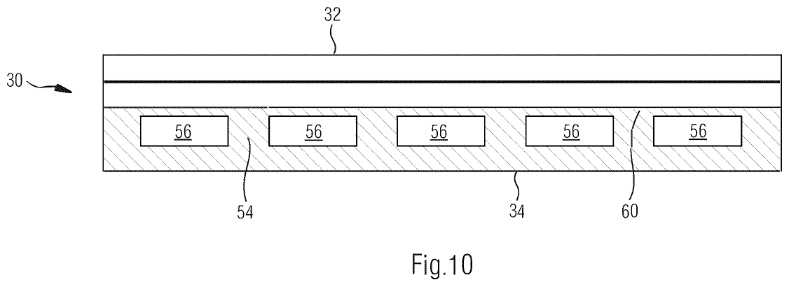

Furthermore, FIG. 10 shows another exemplary embodiment of the first chamber according to the present invention. In contrast to the embodiment shown in FIG. 8, the first chamber in the embodiment shown in FIG. 10 is delimited by the first layer 34 and the second layer 60. This has the advantage that the cooling structure has a self-contained shape, which reduces the risk of the cooling fluid escaping from the first chamber and coming into contact with the photovoltaic module 32.

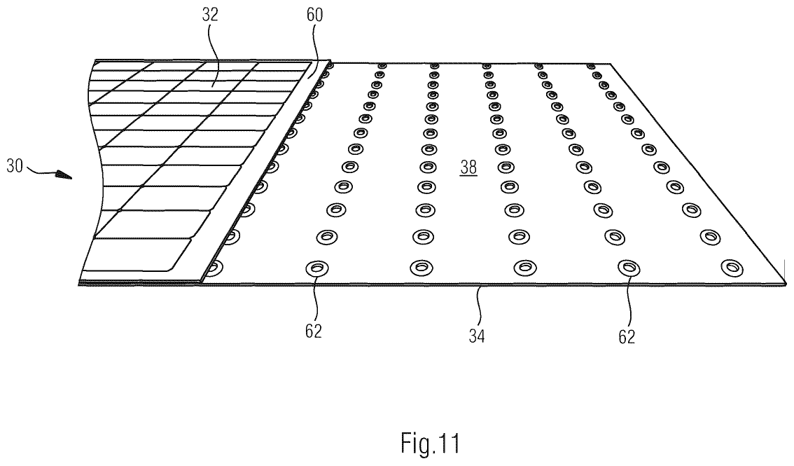

Finally, FIG. 11 shows another exemplary embodiment of the first chamber 38 of the PVT system 30 according to the present invention. As in some of the embodiments described above, the first chamber 38 in the exemplary embodiment according to FIG. 11 is also defined by the first layer 34 and the second layer 60. In the exemplary embodiment shown here, spacers 62 are additionally provided, which are arranged on the first layer 34. Preferably, the spacers 62 are glued to the first layer 34 or welded to the first layer 34. This enables a particularly simple structure of the first chamber, which allows the first chamber to be individualized depending on the field of application. For example, the spacers 62 can be arranged at a small distance from one another if a particularly high mechanical stability of the first chamber is desired. On the other hand, the number of spacers 62 can be reduced and the spacers 62 can be spaced further apart if the stability of the first chamber 38 or the cooling structure is considered less critical and instead the largest possible amount of cooling fluid is to be transported through the first chamber 38. It may also be provided that the first layer 34 has receiving structures, which are designed in particular as receiving grooves. As a result, the spacers can be arranged on the first layer 34 particularly easily and quickly and depending on the specific application, whereby the chamber can be adapted particularly easily and quickly to the requirements of a specific application. In addition, a cooling structure that was previously designed for a specific application can be adapted to the specific application by adding or removing spacers.

### LIST OF REFERENCE NUMERALS

10 PVT system according to the prior art
12 frame
14 glass plate
16 photovoltaic module
18 electrical insulator
20 tube
22 inlet
24 outlet
26 heat insulator
30 PVT system according to the invention
32 photovoltaic module
32a first side of the photovoltaic module
32b second side of the photovoltaic module
34 first layer
36 sidewall
38 first chamber
40 inlet
42 frame
44 first support structure
46 receiving groove
48 second support structure
50 second chamber
52 surface structure
54 channel wall
56 channel
58 interruption
60 second layer
62 spacer

1-15. (canceled)

16. A hybrid photovoltaic thermal energy system for generating electrical and thermal energy, comprising
a photovoltaic module with a first side and a second side opposite the first side, wherein the first side of the photovoltaic module is configured to receive solar energy and convert it into electrical energy;
a cooling structure with at least one first chamber, wherein the cooling structure is arranged on the second side of the photovoltaic module and the first chamber is configured to receive a cooling fluid for cooling the photovoltaic module;
an inlet (40) for introducing the cooling fluid into the fist chamber and an outlet for discharging the cooling fluid from the first chamber.

17. The system according to claim 1, wherein the cooling structure has a flat first chamber, wherein the first chamber has a first side and a second side opposite the first side, and the first side of the first chamber is arranged on the second side of the photovoltaic module.

18. The system according to claim 2, wherein the cooling structure has a second chamber which is arranged on the second side of the first chamber and which is connected to the first chamber via an opening, wherein the opening is in particular slit-shaped or circular.

19. The system according to claim 2, wherein the first chamber is formed from a first layer and a second layer opposite the first layer, as well as sidewalls arranged between the layers, wherein the second layer is arranged on the second side of the photovoltaic module.

20. The system according to claim 4, wherein the first layer or the second layer has a surface structure, or alternatively both layers have a surface structure; wherein the surface structure can in particular be groove-shaped or channel walls are provided by the surface structure, which run parallel or orthogonally to the longitudinal axis of the first layer and/or the second layer and define individual channels within the first chamber.

21. The system according to claim 5, wherein the channel walls extend continuously from one side of the first chamber to the opposite side of the first chamber.

22. The system according to claim 5, wherein at least one channel wall has at least one interruption, wherein at least one interruption is preferably provided in the center of a channel wall.

23. The system according to claim 2, wherein the first chamber is designed as a continuous chamber.

24. The system according to claim 2, wherein the first chamber is made of a plastic material, in particular of polycarbonate or of polymethyl methacrylate, PMMA.

25. The system according to claim 4, wherein spacers are provided between the first layer and the second layer, which define the thickness of the first chamber.

26. The system according to claim 10, wherein the spacers have a circular, annular, rectangular or triangular cross-section and in particular a thickness which is less than 20 mm, preferably less than 10 mm, and particularly preferably less than 5 mm.

27. The system according to claim 10, wherein the spacers are made of plastic.

28. The system according to claim 2, wherein the cooling structure comprises a third layer, wherein the second layer is arranged between the first layer and the third layer.

29. The system according to claim 13, wherein spacers are provided between the first layer and the second layer and between the second layer and the third layer, or in that the second layer has a respective surface structure on its sides opposite the first layer and the third layer, which defines a plurality of fluid channels.

30. The system according to claim 13, wherein the photovoltaic module is designed as a bifacial photovoltaic module with two photoelectrically active sides and that the first chamber of the cooling structure is arranged between the two active sides of the bifacial photovoltaic module.
